(19) United States
(12) Patent Application Publication
(10) Pub. No.: US 2012/0227662 A1
(43) Pub. Date: Sep. 13, 2012

(54) PRESSURE GAUGE WITH INTEGRAL INPUT AND VALVE

(75) Inventor: Joshua D. Coombs, East Lansing, MI (US)

(73) Assignee: AIR LIFT COMPANY, Lansing, MI (US)

(21) Appl. No.: 13/042,488

(22) Filed: Mar. 8, 2011

(51) Int. Cl. G01L 19/08

(52) U.S. Cl. 116/271

(57) ABSTRACT

A pressure gauge device includes a display face, a pressure sensing mechanism capable of outputting the pressure level within a fluid flow device to the display face, an exhaust valve positioned on the display face and an input positioned on the display face, the input capable of controlling a fluid flow source, such as a compressor, to activate the fluid flow source. The exhaust valve and the input may be integrated into the display face by including a valve cutout and an input cutout in the display face. At least a portion of the exhaust valve may extend through the valve cutout, and at least a portion of the input may extend through the input cutout.

### BACKGROUND OF THE INVENTION

The present invention relates to pressure gauge devices and fluid flow, and, more particularly, to devices for displaying and controlling the pressure level within an automobile load assist system.

Load assist systems are well known for aiding vehicles in minimizing changes in ride-height and vehicle dynamics due to loads placed on the vehicle. Some original equipment manufacturers add load-assist products to vehicles, but it is common for owners to install aftermarket load assist products in order to improve their vehicle's load carrying performance.

A typical aftermarket load assist product is known as an air suspension “helper” kit. These kits typically include air springs connected to the vehicle's original suspension system, and a compressor that is connected to the air springs and capable of filling the air springs to a desired level when the vehicle experiences a load. Exhaust valves may be connected to each of the air springs to enable a user to exhaust air from individual air springs until the vehicle ride-height and vehicle dynamics meet desired levels.

The pressure level gauges, compressor controls, and exhaust valve controls for the air springs are typically installed within the vehicle cockpit in order to be accessible to the driver. The pressure gauge (including a display of the pressure level within each air spring), compressor control, and exhaust valves are each mounted within the cockpit, such as on the instrument panel or on the vehicle's “A-pillar,” with all three devices located in separate housings. For instance, three separate “gauge pods” may be positioned in a row extending up the vehicle's A-pillar.

### SUMMARY OF THE INVENTION

The present invention provides a pressure gauge device that integrates a pressure gauge, compressor control and an exhaust valve into a single unit, which may significantly reduce the valuable cockpit space occupied by the load assist product.

In one embodiment, the pressure gauge device includes a display face, a pressure sensing mechanism capable of outputting the pressure level within a fluid flow device to the display face, an exhaust valve positioned on the display face and an input positioned on the display face, the input capable of controlling a fluid flow source, such as a compressor, to activate the fluid flow source. The display face may integrate the exhaust valve and the input by including a valve cutout and an input cutout in the display face. At least a portion of the exhaust valve extends through the valve cutout, and at least a portion of the input extends through the input cutout.

In another embodiment, the pressure sensing mechanism includes a pointer that is movable as a function of the pressure level within said fluid flow device, and the display includes a plurality of markings that are indicative of pressure levels. The pointer is positioned such that movement of the pointer corresponds to a predetermined one of the markings.

In yet another embodiment, the pressure gauge device includes a housing that encloses the pressure sensing mechanism and supports the gauge face, the input and a pair of exhaust valves. Portions of the input and the exhaust valves are positioned within the housing, and portions of the input and the exhaust valves extend out of the housing in order to be accessible to the user. Air tubes connected to the exhaust valves extend through the housing and connect to quick connectors extending from the rear of the housing. Electrical wires connected to the input extend through the housing and exit through the rear of the housing.

The present invention may include a pressure gauge system that includes the pressure gauge with integrated input and exhaust valves, a power source, a compressor and one or more air springs. The input is connected to the power source and the compressor such that the input can be actuated by a user to turn on the compressor. The exhaust valves are connected to the air springs such that a user can actuate the exhaust valves to exhaust air from the air springs. The pressure sensing mechanism is connected to the air springs to display the pressure level within the air springs.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a front view of a pressure gauge according to one embodiment of the present invention.

FIG. 2 is a front view of a pressure gauge according to one embodiment of the present invention with portions removed.

FIG. 3 is a perspective view of a pressure gauge according to one embodiment of the present invention with portions removed.

FIG. 4 is a rear view of a pressure gauge according to one embodiment of the present invention.

FIG. 5 is a side cross sectional view of a pressure gauge according to one embodiment of the present invention.

FIG. 6 is a schematic view of a pressure gauge system according to one embodiment of the present invention.

### DESCRIPTION OF THE CURRENT EMBODIMENT

A pressure gauge according to one embodiment of the present invention is shown in the Figs. and generally designated 10. In general, the pressure gauge 10 includes a housing 12, a gauge face 14 supported within the housing 12, a pressure sensing mechanism 16 supported within the housing for sensing the pressure level within a fluid flow device, such as an air spring 20, an exhaust valve 22 mounted adjacent the gauge face 14 for exhausting fluid from the fluid flow device, and an input 24 connected to a pressure source, such as a compressor 26, for controlling the pressure source to provide a fluid to the fluid flow device. In the illustrated embodiment, the pressure gauge 10 includes two exhaust valves 22 for connection to two fluid flow devices. A display on the gauge face 14 indicates the pressure level within the fluid flow device. The display, exhaust valve 22 and input 24 may all be mounted within the surface area of the gauge face 14 to enable easy access and control by a user.

FIG. 6 shows a schematic layout of a pressure control system 100 including a pressure gauge 10 according to one embodiment of the present invention. The system 100 includes the pressure gauge 10, a power source, such as a 12 volt battery 102, a pressurized fluid source, such as a compressor 26, and a pair of fluid flow devices, such as air springs 106, 108. As shown in FIG. 6, the battery 102 is electrically connected to the input 24 with wire 110, and to a relay 115 with wire 112. The relay 115 is electrically connected to the input with wire 117. The relay 115 is electrically connected to the compressor 26 with wire 119. Both the relay 115 and compressor 26 may be connected to ground via wires 121, 123. The air springs 106, 108 are each fluidly connected to the compressor 26 with pipes 114, 116. The air springs 106, 108 are also each separately fluidly connected to the pressure gauge 10 with pipes 118, 120.

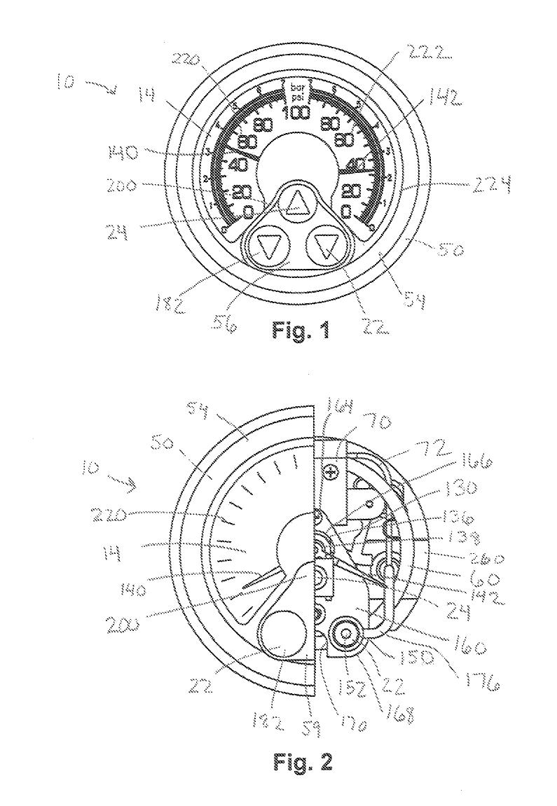

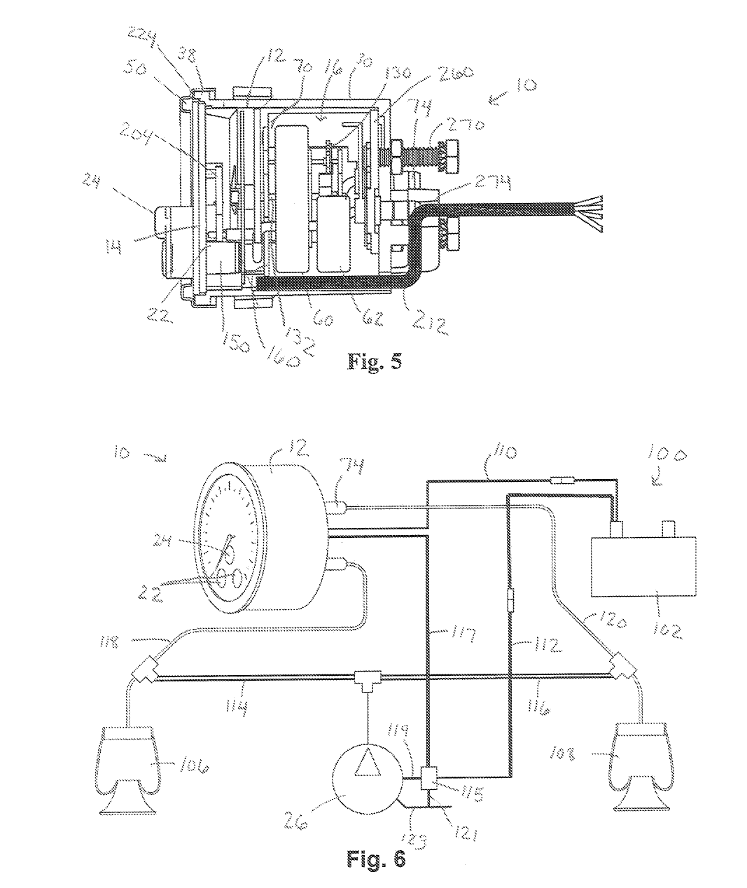

Referring now to FIGS. 1-5, in one embodiment, the housing 12 forms an enclosure and mounting surface for the device. The housing 12 may be formed from a variety of materials, such as metal or molded plastic. As shown, the housing 12 is generally cylindrical, although other shapes may be used, and the housing 12 includes a sidewall 30, a forward end 32, and a rearward end 34. A flange 38 extends outwardly from the sidewall 30 at the open end 32 in a direction generally perpendicular to the sidewall 30. In one embodiment, a bezel 50 is attached to the housing 12 at the open end 32, to at least partially enclose the open end 32. In the illustrated embodiment, a portion 52 of the bezel 50 extends over the flange 38 to secure the bezel 50 to the housing 12. As shown, the bezel 50 includes a ring portion 54 that extends around the entire open end 32 of the housing 12. As discussed in more detail below, the ring portion 54 may extend over a portion of the surface of the gauge face 14 to retain the gauge face 14 within the housing 12. In one embodiment, the bezel 50 includes a frame 56 that extends from the ring portion 52 away from the gauge face 14. The frame 56 includes a sidewall 58 extending from the ring portion 52 and a forward wall 59 extending from the sidewall 58 in a direction generally perpendicular to the sidewall. As illustrated, the frame 56 has a triangular shape when viewed from the front, such that the frame 52 is capable of housing portions of two exhaust valves and an input, as described below. In one embodiment, the frame 56 may be attached to the gauge face 14 by a screw 57 extending through the gauge face 14 and into the frame 56. The rearward end 34 of the housing 12 may include a pair of tabs 36 extending inwardly from the sidewall 30.

The pressure sensing mechanism 16 is capable of indicating the pressure level within a particular fluid flow device. In one embodiment, the pressure sensing mechanism is a Bourdon tube. As illustrated, the present invention includes two Bourdon tubes 60, 62 for sensing and indicating the pressure level within two fluid flow devices, such as air springs 106, 108. Each Bourdon tube generally includes an arc shaped tube having an open end 66 and a closed end 68. The open end 66 of each Bourdon tube 60, 62 is in fluid communication with a fluid flow device. In the illustrated embodiment, the open end 66 of each of the Bourdon tubes 60, 62 extends into a manifold block 70, and into fluid communication with an air tube 72 extending from the opposite side of the manifold block 70. Each of the air tubes 72 is connected to a quick connect 74 that extends from the rearward end 34 of the housing 12. One of the quick connects 74 is connected to air spring 106 via air tube 118 and the other quick connect 74 is connected to air spring 108 via air tube 120. In one embodiment, the quick connect 74 is a barb fitting capable of being inserted into the end of an air hose or tube. Alternatively, the quick connect may be another type of air fitting, such as a threaded fitting or a male or female coupler.

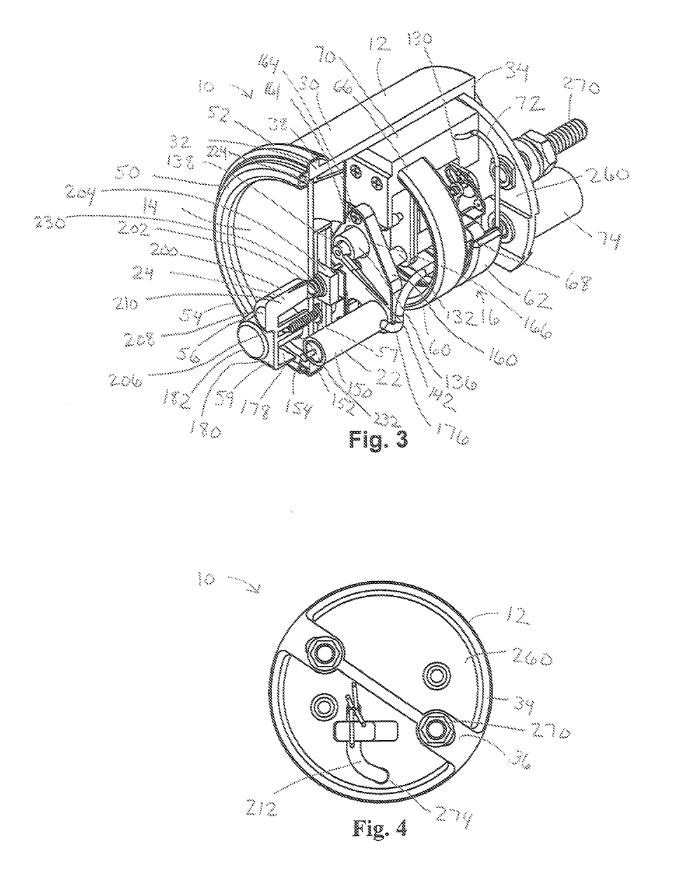

The closed end 68 of each Bourdon tube is connected to a linkage 130, which is connected to a rotatable shaft extending generally perpendicular to the diameter of the Bourdon tubes 60, 62. In one embodiment, a first rotatable shaft 132 is a hollow tube that is disposed coaxially about a second rotatable shaft (not shown). The first rotatable shaft 132 is connected to the linkage 130 of one of the Bourdon tubes 60, such that the first rotatable shaft 132 is rotated upon movement of the closed end 68 of the Bourdon tube 60. The second rotatable shaft is connected to the linkage 130 of the other Bourdon tube 62, such that the second rotatable shaft is rotated upon movement of the closed end 68 of the Bourdon tube 62. Referring now to FIG. 3, the first rotatable shaft 132 may be connected to a cylindrical mounting element 136 that rotates with the first rotatable shaft 132. The second rotatable shaft may be connected to a mounting shaft 138 that extends coaxially within the cylindrical mounting element 136. The mounting shaft 138 may rotate with the second rotatable shaft. As illustrated, a first pointer 140 extends from the cylindrical mounting element 136, and a second pointer 142 extends from the mounting shaft 138. The pointers 140, 142 are positioned adjacent to the gauge face 14. In this arrangement, the pointers 140, 142 each move in response to movement of their respective Bourdon tubes 60, 62 (i.e., each pointer is uniquely associated with one of the Bourdon tubes 60, 62, whereby each pointer 140, 142 moves as a result of a change in pressure within the fluid flow device connected to the particular Bourdon tube 60, 62). In an alternative embodiment, the device 10 may include one or more Bourdon tubes and a corresponding number of pointers. Also, alternative pressure sensing mechanisms can be substituted for the Bourdon tube arrangement.

In one embodiment, the pressure gauge 10 includes a pair of exhaust valves 22. Each exhaust valve 22 is connected to a fluid flow device, such as one of the air springs 106, 108, whereby the exhaust valve 22 can be actuated by a user to exhaust fluid from its respective air spring. In the illustrated embodiment, each exhaust valve 22 is a generally conventional Schrader type valve. Schrader valves are generally conventional, and, therefore, will not be described in great detail. In short, the exhaust valve 22 includes an external tube 150, with a stem 152 within the tube 150 extending along the central axis of the tube 150. The stem 152 includes a head 154 that extends slightly beyond the distal end 156 of the tube 150, providing access to the stem 152 by a user. The stem 152 includes a poppet (not shown) opposite the head 154 that generally seals against a surface within the tube 150. The pin 152 and poppet are biased in the sealed position by a spring (not shown). When the head 154 of the pin 152 is depressed at least partially into the tube 150, the poppet releases from the surface and allows fluid to flow out of the tube 150. Other exhaust valve arrangements may also be used, such as a Presta valve, Dunlop valve or Regina valve.

In the illustrated embodiment, the exhaust valves 22 are mounted to a plate 160. The plate 160 is generally flat, and includes a front surface 161 and a rear surface opposite the front surface. The rear surface is secured to the manifold block 70 with a fastener 164. In one embodiment, the plate 160 includes a hole 166, and the cylindrical mounting element 136 and mounting shaft 138 extend through the hole 166. The plate 160 may additionally include a lower surface 168, and an arc-shaped notch 170 extending into the lower surface 168. In one embodiment, the tube 150 of each Schrader valve 22 is mounted to the plate 160, such that the tubes 150 extend outwardly from the plate 160 in a direction generally perpendicular to the plate 160. As shown in FIG. 3, an air tube 176 extends into the tube 150 of each exhaust valve 22. Each air tube 176 extends from its associated exhaust valve 22 to one of the quick connects 74. As such, each exhaust valve 22 is in fluid communication with the air spring 106, 108 (or other fluid flow device) that is connected to that particular quick connect 74, such that fluid is released from the air spring when the head 154 of the corresponding exhaust valve 22 is depressed.

In one embodiment, the frame 56 of the bezel 50 houses the exhaust valves 22. The frame 56 may include two slots 178 that each receive one of the exhaust valves 22 and generally enclose the exhaust valves 22. In one embodiment, the forward wall 59 defines openings 180 aligned with each of the slots 178, and a resilient cover 182 overlying each of the openings 180. The head 154 of each stem 152 on the exhaust valves 22 extends to a position adjacent the resilient cover 182, such that the head 154 is depressed when a user presses on the resilient cover 182.

The input 24 is connected to the compressor 26, such that the input 24 may be actuated by a user to turn on the compressor 26. In one embodiment, the input 24 includes an upper part 200 of the frame 56, a mechanical button 202 and a circuit board 204. As shown in FIG. 3, the upper part 200 of the frame extends from the forward wall 59 of the frame portion 56, and is flexible with respect to the forward wall 59. For instance, the upper part 200 and the forward wall 59 may be formed from a single piece of material, such as molded plastic, with the upper part 200 and forward wall 59 connected by a thin bridge of the material 206 that acts as a hinge to enable the upper part 200 to flex with respect to the forward wall 59. In one embodiment, the upper part 200 includes a contact portion 208, which projects outwardly from the gauge face 14, and an extension portion 210 that extends toward the gauge face 14. The mechanical button 202 is mounted to the circuit board 204 in a position adjacent to the extension portion 210 of the frame 56, such that when the extension portion 210 is flexed, it contacts the mechanical button 202 and depresses the mechanical button 202. Alternatively, the extension portion 210 may be eliminated, such that the mechanical button 202 is exposed for actuation by a user. In another alternative, the extension portion 210 may include a movable part and a static part, with the movable part capable of being actuated by a user to depress the mechanical button 202. In one embodiment, the circuit board 204 is connected to a wire bundle 212, which extends through the rearward end 34 of the housing 12 and separates into wires 117 and 110 to connect to both the relay 115 and the power source 102. In another embodiment, the input 24 may be connected to the compressor 26 by another connection method for controlling the operation of the compressor 26, including a wireless connection between the input 24 and the compressor 26.

The gauge face 14 forms a display surface for reading the pressure levels outputted from the pressure sensing mechanism 16. In the illustrated embodiment (see FIGS. 1 and 2), the gauge face 14 includes markings for psi levels that interfaces with the pointers 140, 142. As shown in FIG. 1, a first set of markings 220 are located on one side of the gauge face 14 and a second set of markings 222 are located on the opposite side of the gauge face 14. As illustrated, the gauge face 14 is generally transparent with opaque markings, such that the pointers 140, 142 can be positioned behind the gauge face 14 and are visible through the gauge face 14. In another embodiment, the gauge face 14 may be opaque, and the pointers may be positioned in front of the gauge face. In the illustrated embodiment, the gauge face 14 is generally circular, and includes a peripheral edge 224. The gauge face 24 may be arranged to accommodate the input 24 and two exhaust valves 22 positioned within the peripheral edge 224 to reduce the amount of space required for displaying the pressure level, actuating the compressor 26 and exhausting the air springs 106, 108 with exhaust valves 22. For instance, the gauge face 14 may include a series of holes and/or cutouts to receive portions of the input and the exhaust valves. As shown, the gauge face 14 includes an input hole 230 and a pair of exhaust valve holes 232. The input hole 230 is aligned with the extension portion 210 of the frame 56 and the mechanical button 202, and the mechanical button 202 extends through the hole 230 to abut, or nearly abut, the extension portion 210. The exhaust valve holes 232 are each aligned with one of the Schrader valves 22, and the external tube 150 of each Schrader valve extends through one of the holes 232 and into the frame 56. In an embodiment with an opaque gauge face, the gauge face may include an additional hole to allow the pointers to extend through the gauge face 14.

Referring to FIGS. 3-5, in one embodiment, a rear plate 260 is attached to the rear edge 262 of the manifold block 70. The rear plate 260 is a generally solid plate, with a pair of mounting fasteners, such as bolts 270 extending therefrom for mounting the pressure gauge 10 in a desired location. The quick connects 74 may extend from the rear plate 260, with holes extending through the plate 260 to enable each of the quick connects 74 to connect to one of the air tubes 72 extending from the manifold block 70 and to one of the air tubes 176 extending from one of the exhaust valves 22. The rear plate 260 may additionally include a hole 274 that receives the wire bundle 212, such that the wire bundle 212 can pass through the hole 274, where it divides into wires 117 and 110. In one embodiment, the wire bundle 212 extends from the rear surface of the circuit board 204, through the notch 170 in the plate 160, and out of the housing through hole 274.

In operation, the air springs 106, 108 can be filled and exhausted using the single pressure gauge 10. In order to fill the air springs 106, 108, the user may press against the contact portion 208 of the upper part 200 of the frame 56 to flex the upper part 200 and force the extension portion 210 into contact with the mechanical button 202 to depress the mechanical button 202. When the button 202 is depressed, the relay 115 switches the compressor 26 on and the compressor 26 fills the air springs 106, 108 by providing air or another fluid through the pipes 114, 116. In one embodiment, the button 202 operates as a toggle switch, wherein the compressor 26 is activated only while the button 202 is depressed by a user. In another embodiment, a press of the button 202 may turn on the compressor 26 until another press of the button 202, for instance, on contact portion 208, turns off the compressor 26 to stop filling the air springs 106, 108. In yet another embodiment, the compressor 26 may be set to turn off on its own after a predetermined time period or pressure level. The air springs 106, 108 can be exhausted individually by actuating either of the exhaust valves 22. More particularly, a user can exhaust fluid from the air spring 106 by pressing on the cover 182 overlying the Schrader valve head 154 on the exhaust valve 22 corresponding to the air spring 106. When the valve head 154 is depressed, the poppet within the exhaust valve 22 separates from its seal, and air releases from the corresponding air spring 106 via the respective air tube 176, quick connect 74 and the corresponding pipe 118. As the air and/or fluid level in each of the air springs 106, 108 is raised and lowered, the pointers 140, 142 corresponding to each of the air springs 106, 108 move along the markings on the gauge face 14 to display the correct pressure level within the air springs 106, 108.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to packages of any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A pressure gauge system comprising:
a housing;
a gauge face having a plurality of pressure level indicia;
a pointer adjacent to said gauge face;
a pressure sensing mechanism connected to said pointer and to at least one fluid flow device, said pressure sensing mechanism capable of moving said pointer as a function of the pressure level within said at least one fluid flow device to a position adjacent to one of said plurality of indicia, wherein said one of said plurality of indicia corresponds to the pressure level within said at least one fluid flow device;
an exhaust valve mounted to said housing adjacent said gauge face, said exhaust valve connected to said at least one fluid flow device, said exhaust valve including an actuator that is accessible by a user to exhaust fluid from said fluid flow device; and
an input mounted to said housing adjacent said gauge face, said input connected to a fluid source, said fluid source connected to said at least one fluid flow device, said input operable to control said fluid source to provide a fluid to said at least one fluid flow device.

2. The pressure gauge system of claim 1 wherein said gauge face defines a valve cutout, at least a portion of said exhaust valve extending through said valve cutout.

3. The pressure gauge system of claim 2 wherein said gauge face defines an input cutout, at least a portion of said input extending through said input cutout.

4. The pressure gauge system of claim 3 wherein said valve cutout and said input cutout are each disposed completely within said gauge face.

5. The pressure gauge system of claim 4 wherein said housing includes a frame having an exhaust valve portion and an input portion, said frame enclosing at least a portion of said exhaust valve and at least a portion of said input.

6. The pressure gauge system of claim 5 wherein said frame includes a sidewall extending outwardly from said gauge face, said sidewall formed from a single unitary piece.

7. The pressure gauge system of claim 5 wherein said frame includes a sidewall and a forward wall, said input including a portion of said forward wall.

8. The pressure gauge system of claim 7 wherein said portion of said forward wall is movable with respect to a second portion of said forward wall.

9. The pressure gauge system of claim 8 wherein said pressure sensing mechanism includes a Bourdon tube mounted within said housing, said Bourdon tube in fluid communication with said at least one fluid flow device and said pointer.

10. The pressure gauge system of claim 9 wherein said exhaust valve is a Schrader valve including an external tube and a movable stem at least partially disposed within said tube.

11. The pressure gauge system of claim 10 wherein said external tube extends through said exhaust valve cutout in said gauge face.

12. The pressure gauge system of claim 11 wherein said Bourdon tube includes an open end and a closed end, said open end connected to said at least one fluid flow device.

13. The pressure gauge system of claim 4 including a front plate, said front plate having a first surface and a second surface opposite said first surface, said first surface facing said gauge face and second surface facing said Bourdon tube, said Schrader valve mounted to said first surface and extending outwardly from said first surface.

14. The pressure gauge system of claim 13 wherein said pointer is mounted to a rotatable shaft, said rotatable shaft rotating upon movement of said Bourdon tube, wherein said front plate defines a hole, said rotatable shaft extending through said hole.

15. The pressure gauge system of claim 14 wherein said input includes a mechanical button adjacent said movable portion of said frame, said mechanical button connected to said fluid source.

16. A pressure gauge device comprising:
a display face;
a pressure sensing mechanism capable of outputting the pressure level within a fluid flow device to said display face;
an exhaust valve positioned on said display face, said exhaust valve including a valve body and a valve stem that is movable with respect to said valve body between a first position preventing fluid flow through said valve body and a second position allowing fluid flow through said valve body; and
an input positioned on said display face, said input capable of controlling a fluid flow source to activate said fluid flow source.

17. The pressure gauge of claim 16 wherein said display face defines a valve cutout and an input cutout, at least a portion of said exhaust valve extending through said valve cutout, at least a portion of said input extending through said input cutout.

18. The pressure gauge of claim 17 wherein said pressure sensing mechanism includes a pointer that is movable as a function of the pressure level within said fluid flow device, said display including a plurality of markings indicative of pressure levels, said pointer positioned such that movement of said pointer corresponds to a predetermined one of said markings.

19. The pressure gauge of claim 18 wherein said pressure gauge includes a housing enclosing said pressure sensing mechanism, said gauge face supported by said housing.

20. A pressure gauge device comprising:
a housing, said housing including a generally tubular sidewall having a first end and a second end, said housing including a rear wall substantially closing said second end;
a gauge face positioned at said first end, said gauge face including a plurality of markings corresponding to pressure levels, said gauge face defining an input cutout and a valve cutout;
a pressure sensing mechanism within said housing, said pressure sensing mechanism connected to an air port at said second end of said housing;
a pointer connected to said pressure sensing mechanism, said pressure sensing mechanism moving said pointer as a function of the pressure level within said air port, said pointer positioned adjacent to said plurality of markings;
an exhaust valve including a valve body and a stem that is movable within said valve body, said stem movable between a first position preventing fluid flow through said valve body and a second position allowing fluid flow through said valve body, said valve body including a first portion mounted within said housing and a second portion extending through said valve cutout, said first portion connected to said air port, said second portion including said stem; and
an input including a first portion within said housing and a second portion extending through said input cutout, said input capable of controlling a compressor to activate said compressor.
